(19) United States
(12) Patent Application Publication
(10) Pub. No.: US 2015/0014493 A1
(43) Pub. Date: Jan. 15, 2015

(54) Display Elevating Device

(71) Applicant: DONGGUAN CHENG JIE ELECTRONICS CO., LTD., DONGGUAN (CN)

(72) Inventors: Chung-Shiu WU, Dongguan (CN); Ming-Hsin WEI, Dongguan (CN)

(21) Appl. No.: 13/937,789

(22) Filed: Jul. 9, 2013

(51) Int. Cl. F16M 11/04; F16M 11/14

(52) U.S. Cl. CPC F16M 11/046; F16M 11/14
USPC 248/125.2

(57) ABSTRACT

An improvement of display elevating device comprising one supporting portion, a retraction portion and a base, wherein, the supporting portion contains a front panel and a spherical pivot head for fixing a display, wherein the front panel is provided with a spherical clamp for fixing the spherical pivot head, wherein the retraction device consists of a pillar connecting upwards to the supporting portion and a sleeve connecting downwards to the base, said pillar is fixed with a pneumatic cylinder, wherein an axial valve of the pneumatic cylinder is inserted into the base, and the sleeve is provided with an inner groove and a block connecting to the pillar, a key is provided on the base, used for the control of a transmission part to the axial valve of the pneumatic cylinder.

### BACKGROUND

1. Field of the Invention

The “improvement of display elevating device” according to the creation provides a design, which has a simple structure, is easy to operate, and may be used to control the angle and height of a display conveniently and quickly with safety.

2. Descriptions of the Related Art

A LCD is a screen necessary to display the computing content of a host currently. Displays are designed as adjustable structure in correspondence to user height, desktop height and good visual experience for users.

However, elevation adjustable display structures in the market are designed depending on weights of displays. For displays of different sizes or weights, different structures are necessary for manufacturing. It is not only wasting, but also violates economical principle. Further, their elevating methods need to use guiding rail, guiding sleeve and constant force spring. The more the parts are, the higher the cost. Moreover, a display may result in rotation, rising or lowering activities due to the collision of external force. The constantly high cost results from the incapability of modularization.

### SUMMARY OF THE INVENTION

The purpose of the creation is to provide people with an “improvement of display elevating device”, which achieves simple structure, convenient operation, time saving and economics and safety.

The creation is characterized in a simple structure, which is composed of one supporting portion, a retraction portion and a base, wherein, the supporting portion contains a front panel and a spherical pivot head for fixing a display, the front panel is provided with a spherical clamp for fixing the spherical pivot head, while the retraction device consists of a pillar connecting upwards to the supporting portion and a sleeve connecting downwards to the base, said pillar is fixed with a pneumatic cylinder, an axial valve of the pneumatic cylinder is inserted into the base, and the sleeve is provided with an inner groove and a block connecting to the pillar, a key is provided on the base, used for the control of a transmission part to the axial valve of the pneumatic cylinder, thereby, it may achieve the effects of controlling easily azimuth and height of a display with safety.

Wherein, the front panel is provided with a spherical clamp and a spherical pivot head capable of being covered by the spherical clamp, while another end of the spherical pivot head is provided with a hole site protruding a neck portion and a screw rod to pass through the spherical a spherical press cover, it is screwed into an end on the top of a pillar to fix, such that the effect of wide angle adjustment of display azimuth may be achieved.

To achieve the purpose of limiting the rotation of the display, a groove is provided on the inner wall of a sleeve, a block is provided in the groove, the block is fixed to the pillar with a screw rod, thus, the pillar may be limited to the position of the groove by the block to avoid random rotation.

To achieve the purpose of controlling the elevation height, in the “improvement of display elevating device” according to the creation, a pneumatic cylinder and a pillar are set integrally, an axial valve is provided on the bottom, and a key, a transmission part and an activity room are set on the base, the activity part may be provided for the axial valve to enter, and one end of the transmission part is leaned against the axial valve, the other end thereof is leaned against the bottom of the key, a supporting activity part is provided in the transmission part used to support the transmission for power transmission, as a force is applied on the key, for the transmission part under the leverage function of supporting point generated by the supporting activity part, the other end will move upwards to press the axial valve, such that the pneumatic valve is activated to adjust the height thereof.

### BRIEF DESCRIPTION OF THE DRAWINGS

FIG. 1 is a schematic view of an overall appearance according to the creation.

FIG. 2 is an enlarged schematic view of the supporting portion according to the creation.

FIG. 3 is a schematic view of another integral assembly according to the creation.

FIG. 4 is a schematic view of the supporting portion in FIG. 3.

FIG. 5 is a partially enlarged schematic view of the retraction device in FIG. 3.

FIG. 6 is an enlarged schematic view of the base in FIG. 3.

FIG. 7 is an example view showing the second perspective decomposition of the supporting portion.

FIG. 8 is an assembly example view of FIG. 7.

FIG. 9 is an example view showing the third perspective decomposition of the supporting portion.

FIG. 10 is an assembly example view of FIG. 9.

### DETAILED DESCRIPTION OF THE PREFERRED EMBODIMENT

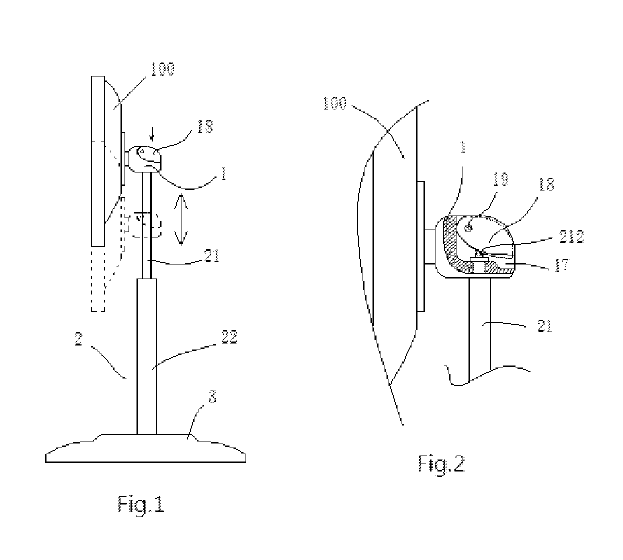

The “Improvement of Display Elevating Device” of the creation is shown in FIGS. 1 and 2. The elevating device has basically a supporting portion 1, a retraction device 2 and a base 3, wherein, for the purpose of achieving the effect to control easily the elevation of a LCD 100, a pillar is designed as a pneumatic cylinder structure with retraction effect, an axial valve 212, which controls the pneumatic cylinder, is set on the top and in a container 17 the supporting portion 1; the container 17 of the supporting portion 1 is provided with an active force application portion 18, which is fixed into the container 17 with a central axis 19, one end may just lean against the axial valve 212, while the elevation position of the display 100 is desired to be controlled, the force application portion 18 is pressed for it to press the axial valve 212 to move, while the pneumatic cylinder of the pillar 21 is started to act, such that the height of the display 100 we need may be adjusted, as the correct position is reached, the force application portion 18 is released to locate the pillar 21.

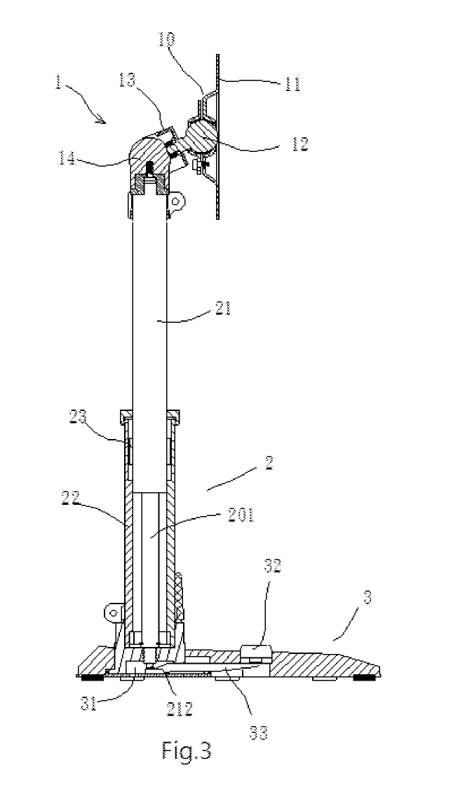

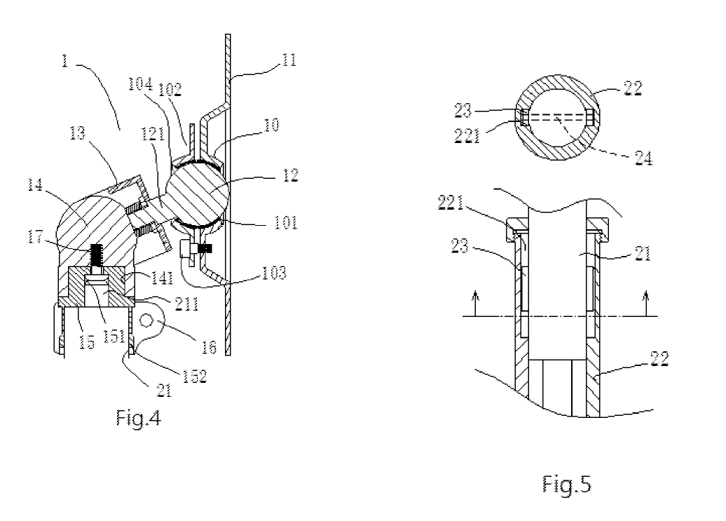

FIG. 3 shows a further design of the “Improvement of Display Elevating Device” of the creation with the effects to implement the purpose of modularization, and for a display to have adjustment of wider angle and azimuth and to prevent display displacement due to accident. It includes basically a supporting portion 1, a retraction device 2 and a base 3. Refer to FIG. 4 concurrently, which is a design with the supporting portion 1 capable of wide angle adjustment for display azimuth. It is provided with a front panel 11 for fixing the display, a spherical clamp 10, and a spherical pivot head 12, which may be covered by a spherical clamp 10, and a fixing rack 13; wherein, the spherical clamp 10 has a spherical container 101 connected with the front panel 11, and a spherical press cover 102 with a hole site 104, the arc space of said spherical container 101 and spherical press cover 102 is smaller than a hemi-spherical arc, and contains the spherical pivot head 12 to fix with a locking member 103. Moreover, the spherical pivot head 12 is provided further with a hole site 104 protruding a neck portion 121 and a screw rod and penetrating through the spherical press cover 102, its screw rod may just be screwed into a spherical end head 14 on the top of the pillar 21 with an inclined angle; to ease installation and to fix the spherical pivot head 12 to the spherical end head 14, the hollow fixing rack 13 is attached to the spherical end head, the front end may be provided for the neck portion 121 of the spherical pivot head 12 to pass through and fix it with a fixed screw fitting, such that the spherical pivot head 12 is fixed at a certain angle.

As shown in the example, said end head 14 is provided with a cavity 141 to be set to a position plug 15 on the pillar, the positioning plug 15 is also provided with a cavity 151 at the bottom thereof to provide a locking member 17 to pass through and lock into the end head 14, and said positioning plug 15 is provided a ring wall 152 to be set to the top end of the pillar 21.

Said retraction device 2 consists of a pillar 21 and a sleeve 22, it is provided with a convex axis 211 on the top end thereof to be positioned just in the cavity 151 of the positioning 15, such that the end head 14 may be positioned on the pillar 21 stably.

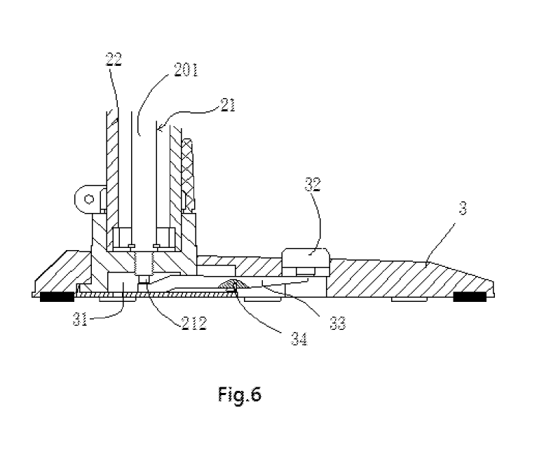

To prevent the pillar 21 from rotating freely to shake the display, as shown in the design example in FIG. 5, a groove 221 is provided on the inner wall of the sleeve 22, a block 23 is provided in the groove 221, the block 23 is fixed to the pillar 21 with the screw rod 24, such that the pillar 21 is limited to the position of the groove 221 without rotation by the block 23, and thereby the display is prevented from rotation. In the example shown in the figure, the groove 221 is provided on two opposite portions of the sleeve 22, and the block 23 is fixed by the screw rod 24.

Wherein, said pillar is designed with a pneumatic cylinder 201 integrally, that is, the pneumatic cylinder 201 may be used as the pillar 21, also, as need, as shown in the example in the figure, the pneumatic cylinder 201 is provided under the pillar, also refer to FIG. 6, which shows a structure controlling the display by the pneumatic cylinder, the axial valve 212 of said pneumatic cylinder 201 is provided at the bottom of the pillar 21, while the base 3 is provided with a key 32, transmission part 33 and an activity room 31, the activity part 31 may be used for the axial valve 212 to enter, and for one end of the transmission part 33 to lean against the axial valve 212, while the other end thereof lean against the bottom of the key 32, a supporting activity part 34 is provided in the transmission part 33, it may support the transmission 33 to transmit power, as a force is applied on the key 32, for the transmission 33 under the leverage function of supporting point of the supporting activity part 34, another end will move upwards to press the axial valve 212, thereby the pneumatic cylinder 201 is activated; because the gas valve of the pneumatic cylinder 201 is opened, it may rise freely or move downwards with a bit of force, until the desired height, the key 32 is released, for the axial valve 212 to close, then all activities are stopped.

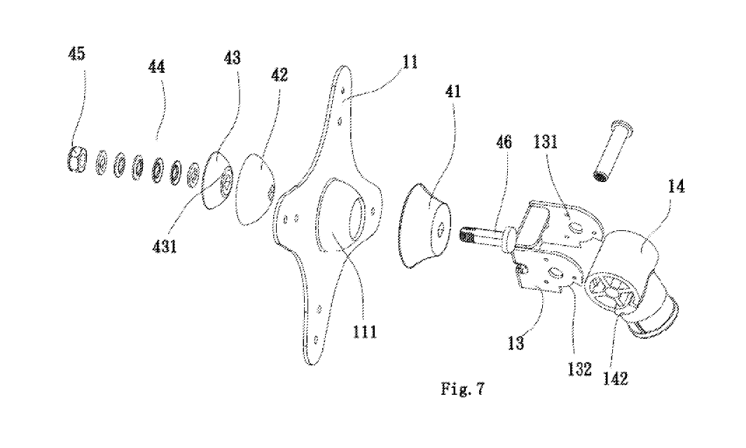

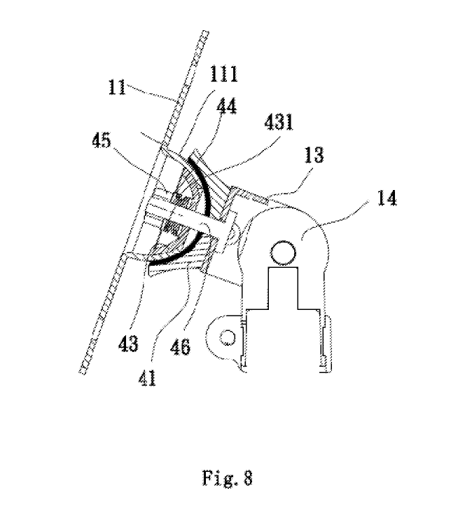

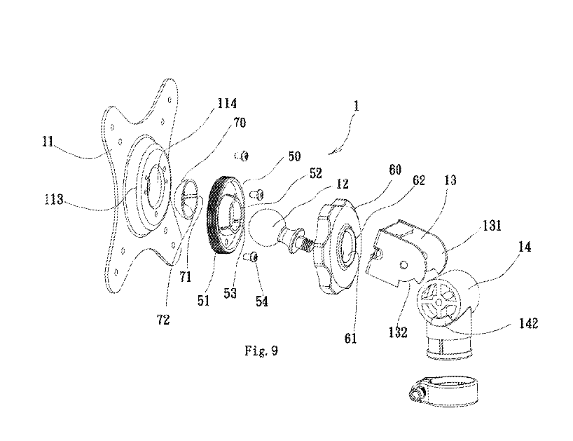

Further, said supporting portion 1 may have a second patent example design as shown in FIGS. 7 and 8. It is located between the front panel 11 and the fixing rack 13, a hollow spherical housing 111 is projected behind the front panel 11, while a hole 112 is located in the middle, compared to the supporting portion 1, it is composed of a carrying linking part 41, a spherical attachment part 42, a spherical surface fixing housing 43, a pad 44, a nut 45, a fixing screw rod 46, wherein, the spherical surface fixing housing 43 is provided with a platform 431 and a hole at the bottom plate; the carrying linking part 41 is located behind the spherical housing 111 for the spherical attachment part 42 to engage, and the spherical attachment part 42 may cover outside the spherical housing 111, with one end to be fixed to the fixing rack 13 with a fixing screw rod 46, while the other end to pass through the carrying linking part 41, spherical attachment part 42, the spherical housing of the front panel 11, the spherical surface fixing housing 43, and pass and combine multiple pads 44, and finally to be screwed into the fixing screw rod 46 with the nut 45 to approximate to the pads 44, as shown in the figure, now, the pads 44 are attached to the platform 431 of the spherical surface fixing housing 43, and the spherical surface fixing housing 43 and the attachment sheet 42 are used to suppress tightly the spherical housing 111 therebetween, such that the effect of fixing movement occurs, because of the flexible pressure of the pads, as the front panel bears of screen suspension, the spherical housing 111 may be adjusted leftward and rightward and upward and downward between the spherical surface fixing housing 43 and the attachment sheet 42 to acquire the effect of suppressing and fixing.

Wherein, the fixing rack 13 ahs two side wings 131 just located on both sides of the end head 14, while at least one wing 131 is positioned with one side of the end head 14 together by the cavity 132 and a projection 142.

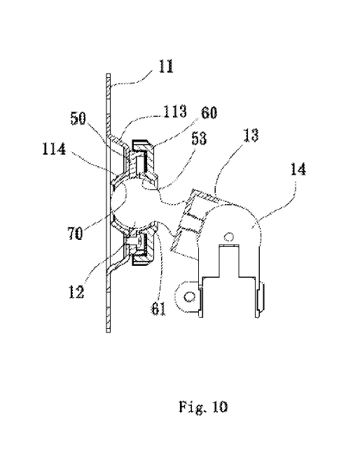

As shown in FIGS. 9 and 10, which show the third patent example design of the supporting portion. The supporting portion 1 covers the spherical pivot head 12 between the front panel 11 and the fixing rack 13, wherein, the front panel 11 is provided with a bearer 113 backwards, a spherical inner arc housing 114 is formed therein, the spherical inner arc housing 114 is formed as a spherical arc surface from back to front in the bearer 113 and is provided with a hole; while the supporting portion 1 consists of a fixing linking part 50, an outer linking part 60 and a spherical supporting cup 70, said fixing linking part 50 is provided with an outer thread 51, a ring clamp 52 is provided at the center backwards, the ring clamp 52 consists at least of three claws, and a spherical cartridge 53 is formed in the ring clamp 52 for the spherical pivot head 12 to inserted, and the fixing linking part 50 is fixed on the bearer 113 of the front panel 11 by the screw 54, while the outer linking part 60 may be screwed to the fixing linking part 50 with inner thread to form a covering shape, the outer linking part 60 is provided with a hole 62, the hole 62 is expanded forwards to form a spherical inner well 61 for the ring clamp 52 to insert, for said spherical supporting cut 70, it is formed backwards as an expansion shape for the spherical pivot head to insert, the front has a hole 72, while the spherical supporting cup 70 is provided with a groove 71 thereon, thereby, the spherical pivot head 12 passes through the outer linking part 60, in the front, the three claws of the ring clamp 52 may be used to expand the opening size feature, for the spherical pivot head 12 to be formed as a shape covering the spherical pivot head 12 once entering the front end, while the spherical supporting cup 70 houses the front of the spherical pivot head 12, after that, it is placed in the spherical inner arc housing 114 of the bearer 113 of the front panel 11, finally, the outer linking part 60 is screwed to cover the fixing linking part 50, then, the spherical pivot head 12 is cover tightly by the spherical cartridge 53 and the spherical supporting cup 70, because of being screwed tightly by the outer linking part 60, thereby, the contact area of the spherical pivot head 12 and the spherical cartridge 53 and the spherical supporting cup 70 is enlarged, under the tight attachment, the friction resistance force is increased, thus, the screen supported by the front panel 11 may have usage angles adjusted leftwards, rightwards, upwards and downwards freely to achieve the effect of stability.

In summary, the “Improvement of Display Elevating Device” of the creation has the following advantages:

1. Easy operation by simply pressing a key to adjust the height of the display.

2. Wide adjustable angle and azimuth for the display that no component is necessary for replacement if displays with different weights are used such that modularized production is available to save cost.

3. Intentional force application on the key is necessary to adjust the height of the display, such that the display will not be impacted to appear elevation by any sudden external force applied on the display or other structures.

4. The elevation of the display comes from the function of the pneumatic cylinder, thus the shortages of conventional devices needing guiding rail, guiding sleeve and constant force spring or rack are prohibited to save manufacturing cost.

### ELEMENTS

1 . . . supporting portion
10 . . . spherical clamp
101 . . . spherical container
102 . . . spherical arc press cover
103 . . . locking member
11 . . . front panel
111 . . . spherical housing
112 . . . hole
113 . . . bearer
114 . . . spherical inner arc housing
12 . . . spherical pivot head
121 . . . neck portion
13 . . . fixing rack
131 . . . side wing
132 . . . cavity
14 . . . spherical end head
141 . . . cavity
142 . . . projection
15 . . . positioning plug
151 . . . cavity
152 . . . ring wall
16 . . . clamp
17 . . . locking member
18 . . . force application portion
19 . . . central axis
2 . . . retraction device
21 . . . pillar
201 . . . pneumatic cylinder
211 . . . projection axis
212 . . . axial valve head
22 . . . sleeve
221 . . . groove
23 . . . block
24 . . . screw rod
3 . . . base
31 . . . activity room
32 . . . key
33 . . . transmission part
34 . . . supporting activity part
41 . . . supporting linking part
411 . . . spherical arc surface
42 . . . attachment sheet
43 . . . spherical surface fixing housing
431 . . . platform
44 . . . pad
45 . . . nut
46 . . . fixing screw rod
50 . . . fixing linking part
51 . . . outer thread
52 . . . ring clamp
53 . . . spherical cartridge
54 . . . screw
60 . . . outer linking part
61 . . . spherical inner well
62 . . . hole
70 . . . spherical supporting cup
71 . . . hole
72 . . . groove
100 . . . display

What is claimed is:

1. An improvement of display elevating device, comprising:
a supporting portion, provided with a front panel used to fix a display, a spherical clamp behind the front panel, and a spherical pivot head covered by the spherical clamp, and a fixing rack;
a retraction device, consists of a pillar and a sleeve, wherein, the pillar and a pneumatic cylinder are formed integrally, a top end is a spherical end, and an axial valve of the pneumatic cylinder is inserted into a bottom base activity room; and
a base, provided with a key, a transmission part and an activity room, an activity part can be just provided for an axial valve to enter, and one end of the transmission part being leaned against the axial valve, the other end thereof is leaned against the key side, a supporting activity part being provided in the transmission part to support the transmission part for power transmission.

2. The improvement of display elevating device of claim 1, wherein the spherical clamp has a spherical container connected with the front panel and a spherical press cover with a hole site, an inner arc space of said spherical container and the spherical press cover is smaller than a semi-spherical arc, and the spherical pivot head can be covered therebetween an fixed with a locking part after that, and the other end of the spherical pivot head is provided with a hole site protruding a neck portion and a screw rod and passing through the spherical press cover, the screw rod thereof can be just screwed into the spherical end on the top of a pillar with an inclined angle.

3. The improvement of display elevating device of claim 1, wherein, a groove is provided on the inner wall of the sleeve, a block is provided in the groove, the block is fixed to the pillar with the screw rod.

4. The improvement of display elevating device of claim 1, wherein, the open fixing rack is formed as a hollow form and attached to the spherical end, the front end may be used for the screw rod of the neck portion of the spherical pivot head to pass through and fixed by a fixing screw linking part, such that the spherical pivot head can be fixed with a certain angle.

5. The improvement of display elevating device of claim 1, said supporting portion being provided with a hollow spherical housing protruding behind the front panel between said front panel and the fixing rack, while the middle having a hole, compared to the supporting portion, it being composed of a supporting linking part, an attachment part, a spherical surface fixing housing, pads, a nut, a fixed screw rod, wherein:
the supporting linking part is located behind the spherical housing, just for the spherical attachment part to inserted therein; the spherical attachment sheet can attach to the spherical housing outside; the spherical fixing housing is attached in the spherical housing outer, provided with a platform and a hole at the bottom plate; the fixing screw rod has one end fixed to the fixing rack, the other end passing through the supporting part, the attachment sheet, the spherical housing of the front panel and the spherical fixing housing, and passing and linking multiple pads, finally, has a nut to screw in to fix the screw rod to proximate the pads, for the pads to attach tightly to the platform of the spherical surface fixing housing and to use the attachment sheet and the spherical fixing housing to suppress the spherical housing therebetween.

6. The improvement of display elevating device of claim 1, the supporting portion may further cover the spherical pivot head between the front panel and the fixing rack, the front panel being provided with a bearer backwards, a spherical inner arc housing being formed therein, the spherical inner arc housing being formed with a spherical arc surface in the bearer from back to front and having a hole;
wherein, the supporting portion consists of a fixing linking part, an outer linking part and a spherical supporting cup;
said fixing linking part has an outer thread, a ring clamp is formed at the center backwards, the ring clamp is composed of at least three craws, while a spherical cartridge is formed in the ring clamp for the spherical pivot head to insert, and the clamp is fixed to the bearer of the front panel with the screw;
the outer linking part may be formed on the fixing linking part with an inner thread to for a covering shape, the outer linking part is provided with a hole, the hole is formed with a spherical inner well for the ring clamp to insert by expanding forwards;
the spherical supporting cup is formed an expansion shape backwards for the spherical pivot head to insert, the front side has a hole, while a grove is provided on the spherical supporting cup; thereby, on the fixing linking part screwed in by the outer linking part the spherical pivot head can be covered tightly by the spherical cartridge and the spherical supporting cup, to provide the screen supported by the front panel to achieve the effects of free adjustment of usage angle stability leftwards, rightwards, upwards and downwards.

7. An improvement of display elevating device, basically having a supporting portion, a retraction device and a base, wherein, a pillar is provided with a pneumatic cylinder, an axial valve controlling the activity of the pneumatic cylinder is provided on the top and resides in a container of the supporting portion; the container of the supporting portion is provided with an active force application portion, a central axis is used to fixed actively the force application portion in the container, one end thereof can just be leaned against the axial valve.
